(19) United States
(12) Patent Application Publication
(10) Pub. No.: US 2006/0206910 A1
(43) Pub. Date: Sep. 14, 2006

(54) Extended CD

(75) Inventors: Ron Kozenitzky, Petach Tikva (IL); Yanki Margalit, Ramat-Gan (IL); Dany Margalit, Ramat-Gan (IL)

Correspondence Address: DR. MARK FRIEDMAN LTD.;c/o Bill Polkinghorn, 9003 Florin Way, Upper Marlboro, MD, 20772, US

(73) Assignee: ALADDIN KNOWLEDGE SYSTEMS LTD.

(21) Appl. No.: 11/075,998

(22) Filed: Mar. 10, 2005

(51) Int. Cl. G11B 7/24; G11B 23/03

(52) U.S. Cl. 720/718

(57) ABSTRACT

The present invention is directed to a CD comprising: electrical data storage; and electrical I/O means, for enabling accessing the electrical data storage by an external device. The electrical data storage may include a smart card memory, a magnetic stripe, a proximity card, and so forth. The electrical data storage may comprise a USB connector, a FireWire connector, and so forth. The connector may be adapted to be folded or detached, thereby enabling the CD to fit a wallet. The electrical storage means may store a key for decrypting at least some content of the optical storage means of the CD. The CD may further comprise circuitry, for rendering at least one function with a content of the electrical data storage, such as providing content to an external device, authentication, encryption or decryption, digital rights management, and security.

### FIELD OF THE INVENTION

The present relates to a CD in which one or more I/O interface units are embedded, e.g. USB, proximity card, magnetic stripe, etc.

### BACKGROUND OF THE INVENTION

A Compact Disc (CD) is defined by www.whatis.com as a small, portable, round medium made of molded polymer (close in size to the floppy disk) for electronically recording, storing, and playing back audio, video, text, and other information in digital form.

Initially, CDs were read-only, but newer technologies allow recording as well. A newer technology, the Digital Versatile Disc (DVD), stores much more data in the same space, which allows storing large scale data such as movies.

CD-ROM (Compact Disc, read-only-memory) is known in the art as an adaptation of the CD oriented to store computer data in the form of text and graphics, as well as hi-fi stereo sound. The original data format standard was defmed by Philips and Sony in the 1983 Yellow Book. Other standards are used in conjunction with it to define directory and file structures, including ISO 9660, HFS (Hierarchal File System, for Macintosh computers), and Hybrid HFS-ISO. Format of the CD-ROM is the same as for audio CDs: a standard CD is 120 mm (4.75 inches) in diameter and 1.2 mm (0.05 inches) thick and is composed of a polycarbonate plastic substrate (underlayer—this is the main body of the disc), one or more thin reflective metal (usually aluminum) layers, and a lacquer coating.

FIG. 1 schematically illustrates a CD, according to the prior art. The CD 10 comprises a region 11, in which the data is impressed. The contour of the CD 10 doesn't necessarily have to be circular, as illustrated on FIG. 1. The data stored within the CD 10 can be accessed by optical means. Thus, its data is stored in an optical manner.

One of the variations of CD is of about 8 cm diameter. FIG. 2 schematically illustrates a CD of the 8 cm diameter in comparable to a credit card contour 19. By modifying the contour of the CD 10 in the manner illustrated in FIGS. 1 and 2, i.e. “cutting” the edges which exceed the dimensions of a credit card contour 19, the modified CD fits a typical wallet size, and therefore can be carried by a user in his wallet. This fact allows using a CD as identification means: on the one hand it can be stored in a wallet and therefore is mobile, on the other hand it can comprise data, e.g. a user ID, which can be accessed by a typical computer.

It is an object of the present invention to provide a method and system for extending the applicability of a CD.

Other objects and advantages of the invention will become apparent as the description proceeds.

### SUMMARY OF THE INVENTION

The present invention is directed to a CD comprising: electrical data storage; and electrical I/O means, for enabling accessing the electrical data storage by an external device. The electrical data storage may include a smart card memory, a magnetic stripe, a proximity card, and so forth. The electrical data storage may comprise a USB connector, a FireWire connector, and so forth. The connector may be adapted to be folded or detached, thereby enabling the CD to fit a wallet. The content of the optical storage means of the CD may correspond to the content of the electrical data means. According to one embodiment of the invention, the electrical storage means store a key for decrypting at least some content of the optical storage means of the CD. The CD may further comprise circuitry, for rendering at least one function with a content of the electrical data storage, such as providing content to an external device, authentication, encryption or decryption, digital rights management, and security.

### BRIEF DESCRIPTION OF THE DRAWINGS

The present invention may be better understood in conjunction with the following figures:

FIG. 1 schematically illustrates a CD, according to the prior art.

FIG. 2 schematically illustrates a CD of the 8 cm diameter in comparable to a credit card contour.

FIG. 3 schematically illustrates an XCD according to one embodiment of the invention.

FIG. 4 illustrates an XCD according to another embodiment of the invention.

FIG. 5 schematically illustrates the components of an XCD, according to one embodiment of the invention.

### DETAILED DESCRIPTION OF PREFERRED EMBODIMENTS

### Detailed Description of Preferred Embodiments

In the context of the present invention, the term CD refers to any variation of CD or DVD, such as CD-ROM, CD-I, CD-RW, CD-ROM XA, CD-W, Photo CD, Video CD, DVD-Ram, DVD-Audio, and so forth.

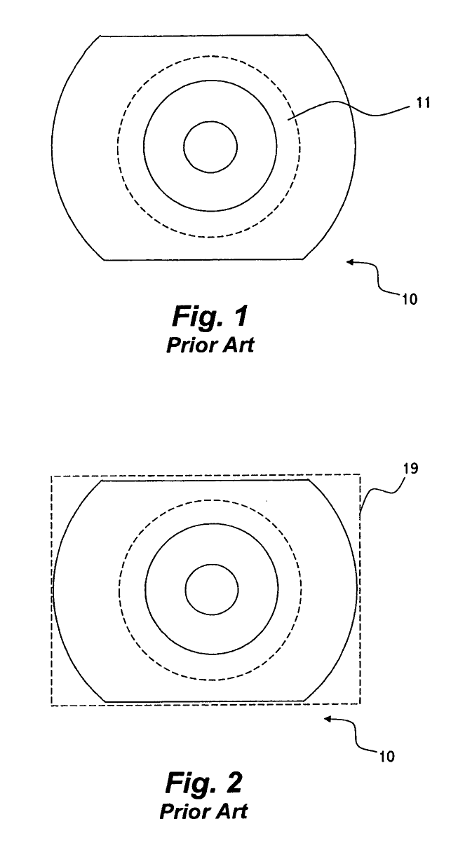

In order to facilitate the description herein, the sides of a CD are referred as follows: the “Data Side” (DS) in which the data is impressed, and the “Label Side” (LS) in which a label or another image is printed. The data region 11 of FIG. 1 resides on the DS.

The term Extended CD (XCD) refers herein to a CD which includes also communication means for communicating with another device (also referred to as external device).

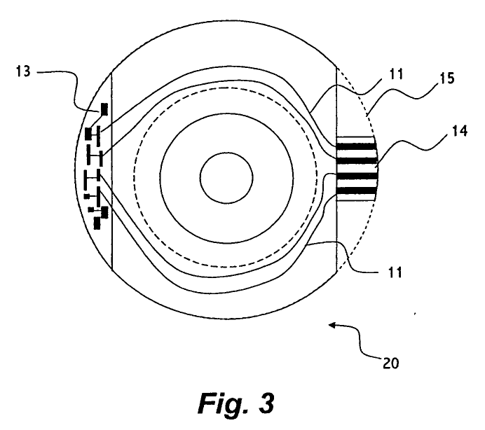

FIG. 3 schematically illustrates an XCD according to one embodiment of the invention. The XCD 20 comprises circuitry 13 and a connector 14 (e.g. USB connector, FireWire, etc.), through which the circuitry 13 communicates with the outside world. Wires 11 connect the connector 14 with the circuitry 13. The wires may be “printed” on the LS, as in a printed circuit.

It should be noted that although the XCD 20 comprises circuitry, its thickness still corresponds to the CD standards. This can be obtained since nowadays technology enables producing electronic components which their thickness is about the same or even less than the thickness of a CD according to CD standards.

As long as the connector 14 does not exceed the circular contour 15, and the thickness of the XCD corresponds to a standard thereof, the XCD can still perform its original purpose, i.e. data storage.

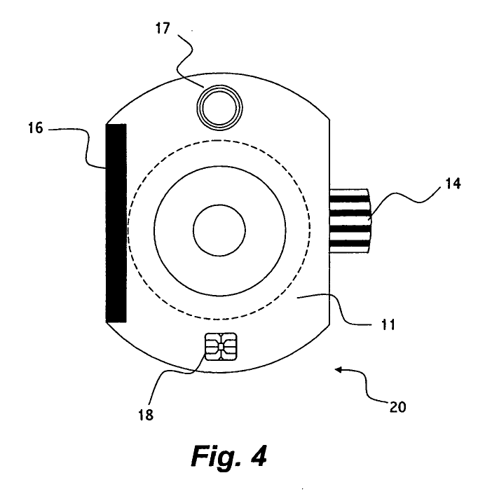

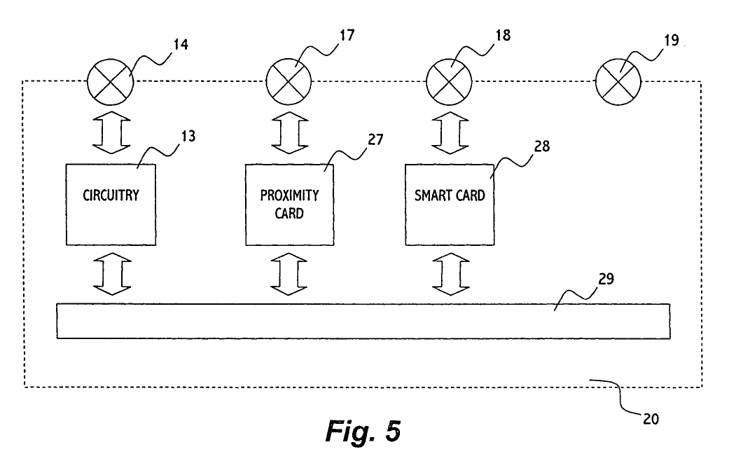

FIG. 4 illustrates an XCD according to another embodiment of the invention. The XCD 20 comprises a magnetic stripe 16 “printed” on its LS, as in a credit card. Also it comprises a proximity coil 17 and smart card contacts 18. Of course not all the I/O components must be present. For example, the XCD may comprise only smart card and contacts thereof, or only a magnetic stripe.

A smart card (a plastic credit card sized card that contains semiconductor chips), magnetic stripe (strip of magnetic recording material on an ID card), and proximity card (a contactless circuitry whose presence and data can be sensed by an interface device not in physical contact with the circuitry) are storage means, like a CD. However, the difference between these storage means and a CD is that while the data stored within a CD can be accessed by optical I/O means, the data stored within a smart card, magnetic stripe and proximity card cannot be accessed by optical means, but rather by electrical I/O means.

Embedding electrical storage means with corresponding I/O means in a CD provides a unique device which may be implemented especially in data security field, i.e. a security device. For example, the XCD can be used as an ATM card, credit card, authentication card, and so forth. The owner of the XCD can open his office door by the proximity coil, use the embedded smart card or magnetic stripe and his picture printed on the CD as a credit card, use the XCD as an ID card on the Internet, as a security token (e.g. the eToken manufactured by Aladdin Knowledge Systems—Tel-Aviv, and so forth.

According to another use of the invention, the impressed data (i.e. the data stored on the CD in the “traditional way”) may be used also for storing a driver or software for operating the XCD. Thus: (a) the driver or software for the XCD can be carried by a user thereof along with the XCD; and (b) the content of the electrical storage means and the optical storage means correspond.

According to one embodiment of the invention, the XCD can be used for DRM (Digital Rights Management). For example, the electrical data storage stores a key which corresponds to the data stored by the optical storage means, e.g. music. In order to play the music, the user has to insert the USB connector into the player, in order to enable the player (e.g. computer) to get the key for decrypting the data stored within the optical data storage of the XCD. Then, the player allows playing the music for a certain period (e.g. 3 hours, one session etc.). According to one embodiment of the invention, the circuitry can be detached from the XCD, thereby enabling using the same circuitry for a plurality of corresponding data chunks (e.g. music, video, etc.), each data chunk on a different XCD.

According to one embodiment of the invention, the USB connector 14 can be folded, or even detached from the XCD. This way the XCD contour does not exceed the contour of a credit card, and accordingly it suits a typical wallet size.

FIG. 5 is a high level block diagram that illustrates the components of an XCD, according to one embodiment of the invention. The XCD 20 may comprise elements of memory, where each one capable of communicating with an external device (not shown) by a corresponding communication means:

circuitry 13, which may comprise memory, communicates with an external device by I/O means 14, e.g. USB connector;

proximity card 27, which may comprises also memory, communicates with an external device by coil 17;

smart card 28, which also may comprise memory, communicates with an external device by contacts 18;

and the magnetic stripe 19 is actually a memory and communication means as well.

The circuitry 13, proximity card 27, and smart card 28 may be interconnected, e.g. by bus 29.

Those skilled in the art will appreciate that the invention can be embodied by other forms and ways, without losing the scope of the invention. The embodiments described herein should be considered as illustrative and not restrictive.

1. A CD comprising:
electrical data storage; and
electrical I/O means, for enabling accessing said electrical data storage by an external device.

2. A CD according to claim 1, wherein said electrical data storage includes a smart card memory.

3. A CD according to claim 1, wherein said electrical data storage includes a magnetic stripe.

4. A CD according to claim 1, wherein said electrical data storage includes a proximity card.

5. A CD according to claim 1, wherein said electrical I/O means includes a connector selected from a group consisting of: USB connector, FireWire connector.

6. A CD according to claim 5, wherein said connector is adapted to be folded or detached, thereby enabling said CD to fit a wallet.

7. A CD according to claim 1, wherein at least some content of the optical storage means of said CD corresponds to at least some content of said electrical data means.

8. A CD according to claim 1, wherein said electrical storage means stores a key for decrypting at least some content of the optical storage means of said CD.

9. A CD according to claim 1, further comprising circuitry, for applying at least one function to a content of said electrical data storage.

10. A CD according to claim 10, wherein said at least one function includes providing said content to an external device.

11. A CD according to claim 10, wherein said at least one function includes authentication.

12. A CD according to claim 10, wherein said at least one function includes encryption or decryption.

13. A CD according to claim 10, wherein said at least one function includes digital rights management.

14. A CD according to claim 10, wherein said at least one function includes security.

15. A data storage device, comprising:
a body having a form factor of a CD;
optical storage means, integral with said body;
electrical data storage, operationally connected to said body; and
electrical I/O means, for enabling accessing said electrical data storage by an external device

16. A security device, comprising:
a body having a form factor of a CD;
optical storage means, integral with said body;
electrical data storage, operationally connected to said body; and
electrical I/O means, for enabling accessing said electrical data storage by an external device
